(19) United States
(12) Patent Application Publication
(10) Pub. No.: US 2023/0401362 A1
(43) Pub. Date: Dec. 14, 2023

(54) SYSTEMS AND METHODS FOR MANUFACTURING ADAPTIVE PERIPHERAL DEVICES

(71) Applicant: Microsoft Technology Licensing, LLC, Redmond, WA (US)

(72) Inventors: Elizabeth Rose MILLER, Mounds, OK (US); Benjamin Casey KELLY, Dublin (IE); Ebin BENNY, Dublin (IE); Jurgen Karl BRENKERT, Bellevue, WA (US); Balin Dean LUSBY, Redmond, WA (US); Chantal OLIEMAN, Seattle, WA (US); Samuel Antonio VALENZUELA PEREZ, Dublin (IE); Susanne DUSWALD, Dublin (IE); Tara HANRATTY, Curry (IE); Arlene K. CARTER, Murfreesboro, TN (US); Cade Dowling RYAN, Dublin (IE); Luca TOSCANO, Dublin (IE); David Ciaran HOPKINS, Dublin (IE); Darragh Garrett MURPHY, Dublin (IE); Emilio DETTORI, Dublin (IE); Luc Eugène VAN DEN ENDE, Seattle, WA (US)

(21) Appl. No.: 17/840,379

(22) Filed: Jun. 14, 2022

(51) Int. Cl. G06F 30/27; G06F 30/17

(52) U.S. Cl. CPC G06F 30/27; G06F 30/17; G06F 2113/10

(57) ABSTRACT

A method of manufacturing an electronic device peripheral includes obtaining a model of a peripheral, where the model has a plurality of components. The method further includes identifying one or more fit components of the model and identifying one or more functional components. The method includes receiving at least one change to the model and, based at least partially on the at least one change, changing at least one property of a fit component of the one or more fit components without altering a functional component of the plurality of components before providing at least an altered fit component to an additive manufacturing device.

### BACKGROUND

### Background and Relevant Art

Adaptive peripherals and game controllers can provide individuals with limited or different mobility the ability to engage with software applications. For example, adaptive peripherals and game controllers can allow an individual with limited manual mobility to play video games that conventionally require extensive manual dexterity. As the mobility and abilities of individuals can vary greatly, many conventional adaptive peripherals and game controllers are custom-made to the individual by hand and can be prohibitively expensive.

### BRIEF SUMMARY

In some embodiments, a method of manufacturing an electronic device peripheral includes obtaining a model of a peripheral, where the model has a plurality of components. The method further includes identifying one or more fit components of the model and identifying one or more functional components. The method includes receiving at least one change to the model and, based at least partially on the at least one change, changing at least one property of a fit component of the one or more fit components without altering a functional component of the plurality of components before providing at least an altered fit component to an additive manufacturing device.

In some embodiments, a method of manufacturing an electronic device peripheral includes obtaining a model of a peripheral, where the model having a plurality of components. The method further includes identifying one or more functional components of the model and identifying at least one remaining component of the model that is not a functional component of the one or more functional components of the model. The method includes designating one or more of the at least one remaining components of the model as a fit component. The method includes receiving at least one change to the model and, based at least partially on the at least one change, changing at least one property of a fit component of the one or more fit components without altering a functional component of the plurality of components before providing at least an altered fit component to an additive manufacturing device.

In some embodiments, a system for manufacturing an electronic device adaptive peripheral includes an additive manufacturing device and a computing device in data communication with the additive manufacturing device. The computing device includes a processor, a communication device in data communication with the processor, and a hardware storage device in data communication with the processor. The hardware storage device has instructions stored thereon that, when executed by the processor, cause the computing device to obtain a model of a peripheral, where the model has a plurality of components. The instructions further cause the computing device to identify one or more fit components of the model and identify one or more functional components. The instructions further cause the computing device to receive at least one change to the model and, based at least partially on the at least one change, change at least one property of a fit component of the one or more fit components without altering a functional component of the plurality of components before sending a transmission to the additive manufacturing device to manufacture a part of the peripheral corresponding to an altered fit component.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a top view of an adaptive controller hub, according to at least some embodiments of the present disclosure;

FIG. 2 is a perspective view of a model of an adaptive peripheral, according to at least some embodiments of the present disclosure;

FIG. 3 is a cross-sectional view of a model of an adaptive peripheral, according to at least some embodiments of the present disclosure;

FIG. 4-1 through FIG. 4-3 illustrate different methods of altering a property of a component of a model, according to at least some embodiments of the present disclosure;

FIG. 5 is a flowchart illustrating a method of manufacturing an adaptive peripheral, according to at least some embodiments of the present disclosure;

FIG. 6 is a flowchart illustrating another method of manufacturing an adaptive peripheral, according to at least some embodiments of the present disclosure;

FIG. 7 is a schematic illustration of a system for manufacturing an adaptive peripheral, according to at least some embodiments of the present disclosure; and

FIG. 8 is a schematic representation of a machine learning system used in a method of manufacturing an adaptive peripheral, according to at least some embodiments of the present disclosure.

### DETAILED DESCRIPTION

The present disclosure generally relates to systems and methods for manufacturing a peripheral for an electronic device. More particularly, systems and methods described herein allow for manufacturing of a customized adaptive peripheral for use with electronic devices.

In some embodiments, systems and methods according to the present disclosure allow a user to customize one or more parts of a peripheral prior to manufacturing, such that the manufactured part(s) meet the user's needs while remaining interoperable with other components of the peripheral. Systems and methods according to the present disclosure may reduce costs and manufacturing time while improving comfort and performance of the manufactured adaptive peripherals.

Depending on a user's physical abilities, an adaptive peripheral for the user may require customized dimensions, weight, resistance, shape, material, or color. Conventionally, a custom adaptive peripheral is commissioned and crafted by hand to the user's specifications. Newer manufacturing methods may use additive manufacturing or three-dimensional (3D) printing to rapidly produce a custom part to the user's specifications. However, modeling and designing the custom part for additive manufacturing conventionally requires computer assisted design (CAD) modeling software and experience using the CAD modeling software, which creates another barrier for users needing adaptive peripherals.

In some embodiments, a base model of a peripheral is obtained, and a user provides changes to the base model that can be applied to one or more components of the model to allow the alterations to accommodate the user's needs while the parts remain interoperable and compatible with one another to simplify manufacturing and assembly. For example, an existing CAD model may include a plurality of components to the CAD model that are independently editable. In some embodiments, a system or method according to the present disclosure identifies at least one component of the plurality of components as a fit component, which is editable to the user for customization purposes, and identify at least one component as a functional component, which is non-editable or locked to the user for customization purposes. In at least one example, the user has the option to alter or customize the CAD model through a webpage or web portal by changing properties and/or values of the fit components, while the properties and/or values of the functional components remain locked.

Peripheral controllers can meet the needs of a variety of individuals by allowing the functionality of a conventional controller to be divided or duplicated across the peripheral controllers through a controller hub. The controller hub has a plurality of ports therein to allow peripheral controllers to provide adaptive input mechanisms for users with limited or different mobility. For example, a user with limited mobility in her left hand may have a challenge providing directional inputs on the left thumbstick of a conventional game controller, such as a MICROSOFT XBOX CONTROLLER, an adaptive controller/peripheral can provide a secondary input to provide directional inputs via an adaptive controller/peripheral.

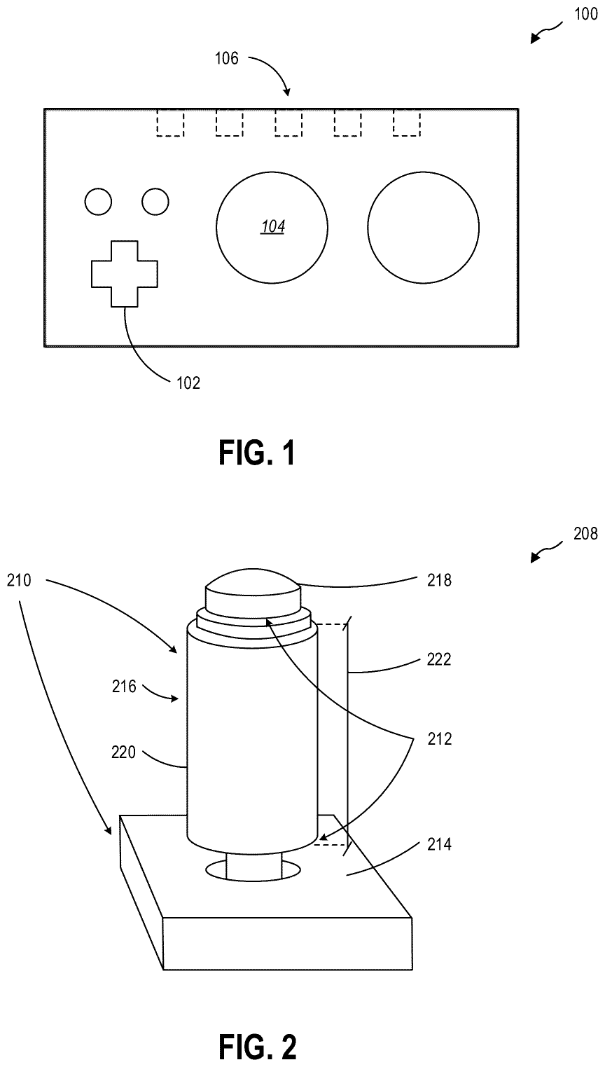

Adaptive peripherals may be connected to a hub with one or more inputs on the hub to provide additional or secondary inputs. In some embodiments, an adaptive peripheral is connected to a hub with one or more inputs to provide inputs independently of input mechanism on the hub. FIG. 1 is a top view of a MICROSOFT XBOX ADAPTIVE CONTROLLER HUB. The hub 100 has a directional input device 102 and a plurality of input buttons 104. The hub 100 has a plurality of input ports 106 into which a connector may be inserted to connect an adaptive peripheral device and through which the adaptive peripheral device may communicate with the hub 100 and a game console or other computer connected to and in communication with the hub 100.

FIG. 2 is an embodiment of a CAD model 208 (e.g., JAVASCRIPT computer assisted design (JSCAD), .stl format, .stp format, or other open-source or propriety format) of an adaptive peripheral that may connect to a hub (such as the hub 100 described in relation to FIG. 1). The model 208 includes and/or represents a plurality of components in the adaptive peripheral. In some embodiments, the plurality of components includes fit components 210 and functional components 212. The functional components 212 include any component or part of the model 208 that includes a connection interface with another component or a mechanical or electrical interface to receive an input to the peripheral. In some embodiments, the fit components 210 include any remaining portion of the CAD model that is not a functional component 212.

In some embodiments, the fit components 210 include a housing 214, a stick 216, a button topper 218 or other force input surface, a grip 220, a handle, a mouthpiece, or other portion of the model that corresponds to a contact surface or other surface of the peripheral that a user may touch during use. The fit components 210 may be editable to alter one or more properties or values to improve the comfort or performance of the adaptive peripheral for the user. For example, increasing a height 222 of the stick 216 above the housing 214 may increase the leverage a user applies to the stick 216 for directional inputs, reducing fatigue and improving comfort. In another example, decreasing the height 222 of the stick 216 above the housing 214 can reduce the travel distance of the stick 216 relative to the housing 214 (e.g., the stick 216 moves less when pushed through a 45° range of motion), which may improve control for a user and improve comfort while providing directional inputs to the adaptive peripheral.

In some embodiments, the editable properties or values of the fit component 210 of a model 208 include any of length, width, height, thickness, perimeter shape (such as a plan-view or cross-sectional view shape), color, or material. In some embodiments, the material may be changed or selected based on one or more desired material properties, such as a coefficient of friction (such as for a grip 220), an elastic modulus (such as for a flexible fit component), or a vibration damping property. For example, a model may include a plurality of available materials and a user selection of a coefficient of friction may cause the material assigned to the fit component to change in the model to approximate or match the desired coefficient of friction. In another example, a model may include a plurality of available materials and a user selection of a compressibility of a grip (such as for an input mechanism that receives an input from a user compressing a stick 216 in their grip) may cause the material assigned to the fit component to change in the model to approximate or match a desired elastic modulus. In other examples, a change to the wall thickness of the grip may allow the same material to exhibit the same compressibility.

The model 208 may include a value or characteristic associated with each component of the model that designates the component as either a functional component or a fit component. For example, a model 208 may include discrete components within the model 208 that combine to form the complete model 208 of the adaptive peripheral. In some embodiments, a model 208 according to the present disclosure allows for subcomponents of a single component, where each subcomponent may be designated a fit component or a functional component.

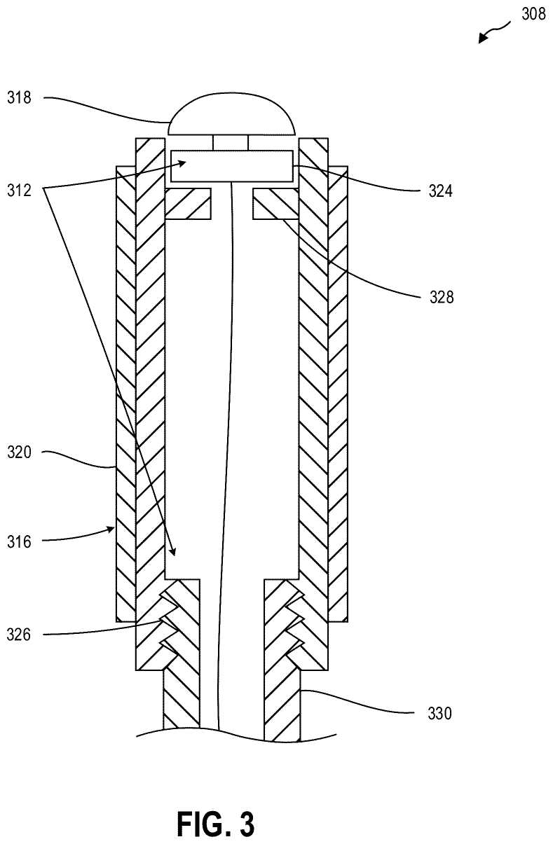

FIG. 3 cross-section of an embodiment of a portion of a model 308 of an adaptive peripheral. The model 308 includes at least a stick 316 that includes both fit components 310 and functional components 312. In some embodiments, at least one fit component 310 or functional component 312 is subcomponent of another component. For example, in the illustrated embodiment, the stick 316 includes a portion that includes a threaded interface 326 that is a functional component 312, a second portion that includes a support 328 and enclosure for a mechanical switch 324, where the support is also a functional component 312 (along with the mechanical switch 324). The functional components 312 have at least dimensions or other properties that become locked or non-editable in the model properties to ensure the functional components 312 continue to be interoperable with other functional components 312 of the model 308.

In some embodiments, the functional components include a mechanical switch, an optical switch, a magnetic switch, a pressure sensor, a potentiometer, a connection interface, or other components or subcomponents that measure inputs and/or connect a part of the peripheral to another part of the peripheral. For example, the threaded interface 326 of the stick 316 is designated as a functional component 312 to ensure the complementary interface of the potentiometer 330 will connect to the stick 316. In some embodiments, editable properties or values of the functional components 312 include color or other properties that will not alter the function, size, or shape of the functional components 312.

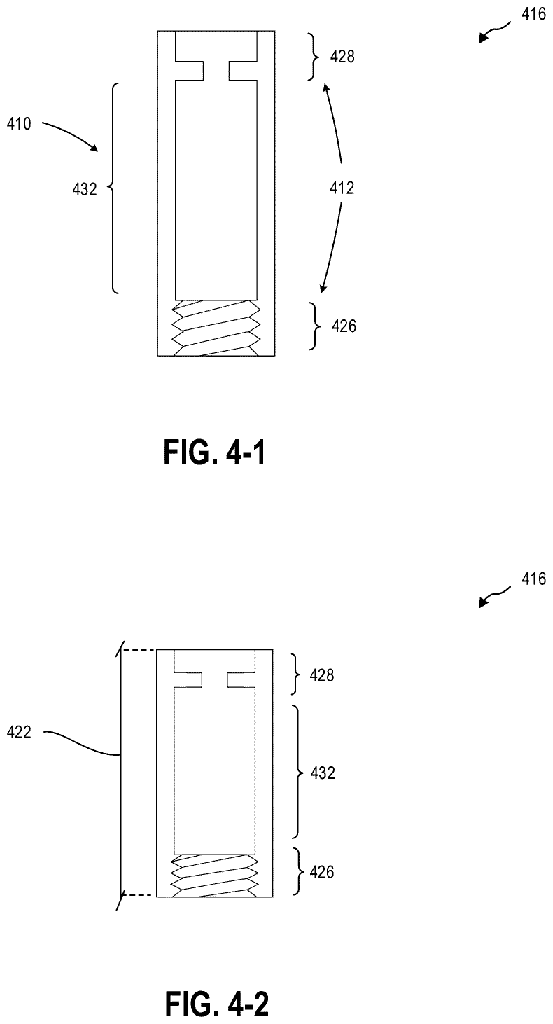

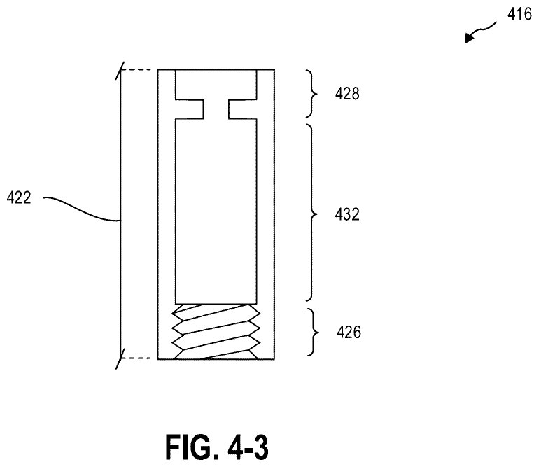

As described above, a model may be or include an assembly that, in turn, includes a plurality of components that, in turn, include a plurality of subcomponents. The components and subcomponents may each be a fit component or a functional component. In some embodiments, a component includes integrally formed subcomponents. For example, FIG. 4 illustrates an embodiment of a stick 416 (similar to the stick 316 of FIG. 3) that includes a first subcomponent including the threaded interface 426 (e.g., to screw onto a potentiometer) and a second subcomponent including a support 428 for a mechanical switch (e.g., an input button). The stick 416 further includes a third subcomponent that includes a body 432 that connects the first subcomponent to the second subcomponent.

In the illustrated embodiment, the stick 416 is integrally formed from a single piece of material, and many conventional CAD models may consider the stick 416 to have a single set of dimensions in the component properties. However, in some embodiments, the first subcomponent and second subcomponents are functional components 412, while the third subcomponent of the stick 416 is a fit component 410.

FIG. 4-2 illustrates at least one problem caused by treating the stick 416 component as a unitary component without subcomponents. When scaling a height 422 of the stick 416, the aspect ratio of all portions of the stick 416 are foreshortened equally, producing a foreshortening of the first subcomponent and second subcomponent. For example, a pitch of the threaded interface 426 changes, rendering the threaded interface 426 of the first subcomponent incompatible with the threaded interface of the potentiometer for measuring a position of the stick 416. In another example, a depth of the support 428 for the mechanical switch of the button is reduced, compromising the retention of the mechanical switch in the stick 416. To ensure the functional components of the stick 416 component maintain interoperability, the third subcomponent including the body 432 of the stick 416 should be foreshortened, such as illustrated in the embodiment of FIG. 4-3.

FIG. 4-3 is a side-cross sectional view of the stick 416 component with a foreshortened height 422. The third subcomponent including the body 432 is a fit component and allows the user to edit the dimensions of the third subcomponent. In some embodiments, the dimensions (and, optionally, other properties) of functional components (e.g., the first subcomponent and second subcomponent) remain fixed during the alteration of the height 422 of the stick 416 component. Therefore, the dimensions of the threaded interface 426 and the support 428 included in the first subcomponent and second subcomponent remain unchanged, and the threaded interface 426 and the support 428 maintain interoperability with other components of the assembly in the model.

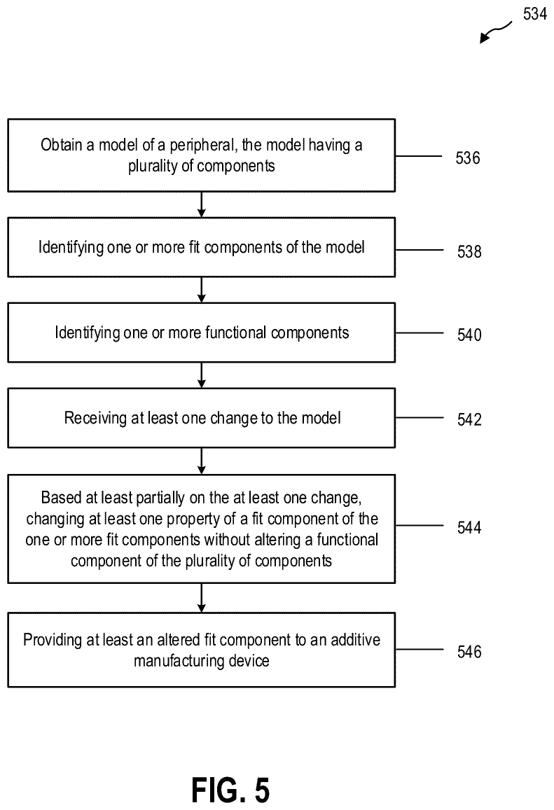

FIG. 5 is a flowchart illustrating an embodiment of a method 534 of manufacturing a custom peripheral for providing inputs to an electronic device. In some embodiments, the method 534 includes, at a computing device, obtaining a model of a peripheral, where the model is an assembly containing a plurality of components, at 536. In some embodiments, at least one component of the model has a plurality of subcomponents. In some embodiments, obtaining the model includes receiving the model at a processor or system memory from a local hardware storage device. In some embodiments, obtaining the model includes receiving the model at a processor or system memory from a remote hardware storage device, such as from cloud storage or another server computer accessed via a network.

The method 534 further includes identifying one or more fit components of the model at 536. In some embodiments, identifying one or more fit components of the model includes reading at least one property of the components and/or subcomponents of the model. For example, some models obtained according to an embodiment of the method 534 described herein may include a fit component property or tag in the properties of the CAD model.

In some embodiments, the method 534 further includes identifying one or more functional components of the model at 538. In some embodiments, identifying one or more functional components of the model includes reading at least one property of the components and/or subcomponents of the model. For example, some models obtained according to an embodiment of the method 534 described herein may include a functional component property or tag in the properties of the CAD model.

The method 534 further includes, in some embodiments, receiving at least one change to the model at 542. In some embodiments, the change is received from a webpage or web portal that provides the change at least one property of the model. In some embodiments, the change is received at the computing device from a human interface device connected to the computing device. Based at least partially on the at least one change, the method 534 further includes changing at least one property of a fit component of the one or more fit components without altering a functional component of the plurality of components. As described herein, the properties and/or values of the functional components may be locked from alteration to maintain interoperability of the functional components. The properties of the fit component(s) are editable to allow the user to customize a fit of the peripheral to the user's body for comfort and performance.

In some embodiments, the method 534 includes providing at least an altered fit component to an additive manufacturing device at 546. The additive manufacturing device may then print a physical part according to the properties and/or values of the altered fit component to produce part of the peripheral.

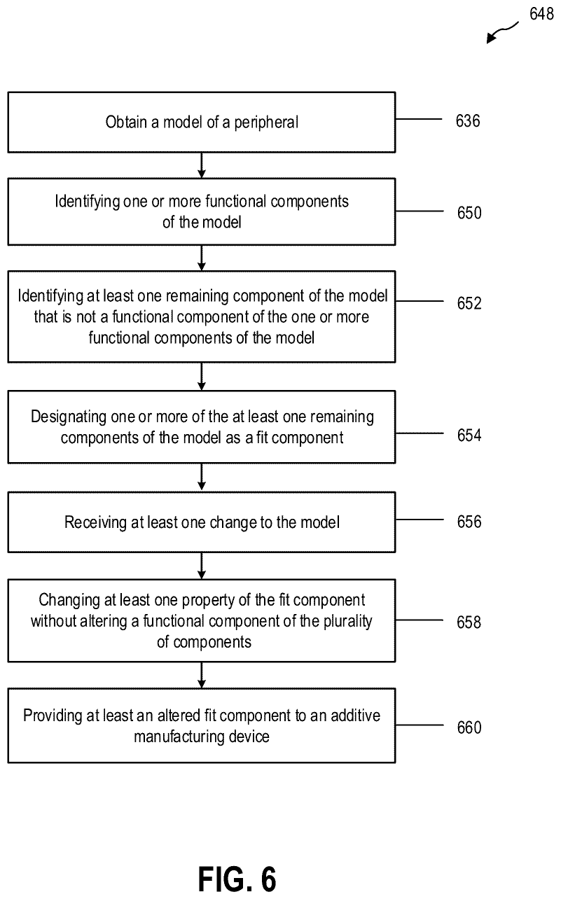

In some embodiments, the CAD model does not include properties and/or values to distinguish between fit components and functional components. In at least one embodiment, the CAD model is a unitary model that includes only one component. FIG. 6 is a flowchart illustrating an embodiment of a method of manufacturing an adaptive peripheral from a model lacking information about fit components and/or functional components.

The method 648 includes obtaining a model of a peripheral at 636 at a computing device, similar to as described in relation to FIG. 5, but the model does not include properties and/or values to distinguish between fit components and functional components. The method 648 then includes identifying the functional components and fit components to distinguish therebetween before alterations are made to a component or subcomponent of the model.

In some embodiments, the method 648 includes identifying one or more functional components of the model at 650. In some embodiments, identifying one or more functional components includes parsing a component name, title, properties, or values to identify a term associated with functional components, such as “switch”, “thread”, “button”, or “connector” that allows the computing device to identify a component as a functional component. In some embodiments, the computing device uses object recognition to identify functional components, such as identifying a helical structure as a threaded interface. The computing device may designate the identified component as a functional component and subsequently identify at least one remaining component of the model that is not a functional component of the one or more functional components of the model at 652. The identified remaining component is then designated as a fit component at 654.

In some embodiments, the method 648 splits a unitary model (i.e., a model received without any components of the model) based at least partially on object recognition to identify functional components, such as identifying a helical structure as a threaded interface. The computing system may then designate a portion of the model adjacent to the functional component as part of the functional component to ensure that alterations to a remaining portion of the model do not compromise the interoperability of the identified functional component.

The method 648 further includes receiving at least one change to the model at 656 (such as described in relation to FIG. 5) and changing at least one property of the fit component without altering a functional component of the one or more functional components of the model at 658 before providing at least an altered fit component to an additive manufacturing device at 660.

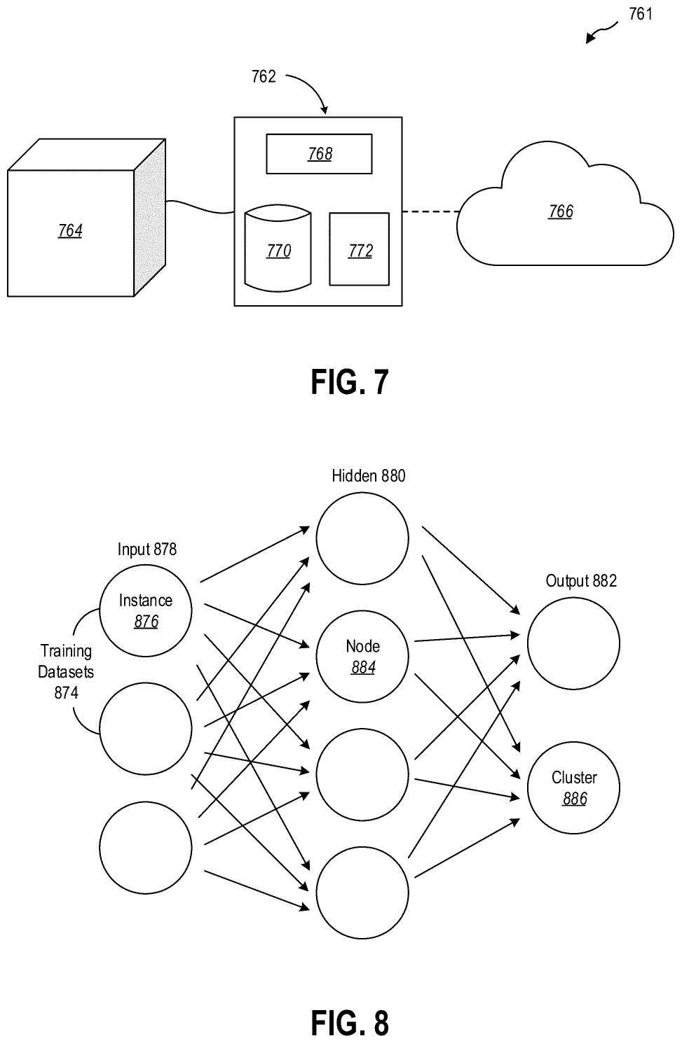

FIG. 7 is schematic representation of an embodiment of a system 761 for manufacturing an adaptive peripheral. The system 761 includes, in some embodiments, a computing device 762 in data communication with an additive manufacturing device 764. In some embodiments, the computing device 762 is further in data communication with a network 766 through which the computing device may obtain models of peripherals. In some embodiments, the computing device 762 is local to the additive manufacturing device 764. In some embodiments, the computing device 762 is in data communication with the additive manufacturing device 764 via the network 766.

The computing device 762 includes a processor 768 in data communication with a hardware storage device 770 and in data communication with a communication device 772. In some embodiments, the hardware storage device 770 is any non-transient computer readable medium that may store instructions thereon. The hardware storage device 770 may be any type of solid-state memory; volatile memory, such as static random access memory (SRAM) or dynamic random access memory (DRAM); or non-volatile memory, such as read-only memory (ROM) including programmable ROM (PROM), erasable PROM (ERPOM) or EEPROM; magnetic storage media, such as magnetic tape; platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory, or any other non-transient storage media. In some embodiments, the hardware storage device 770 is local to and/or integrated with the computing device. The hardware storage device 770 has instructions stored thereon that, when executed by the processor 768, cause the computing device 762 to perform at least part of any of the methods described herein. In some embodiments, the computing device 762 may communicate with the additive manufacturing device 764 to perform at least a part of a method. For example, providing at least the altered fit component to the additive manufacturing device 764 may cause the additive manufacturing device 764 to change filaments for a printing of the part corresponding to the altered fit component.

In some embodiments, the communication device 772 is a wired communication device, such as an ethernet network card that allows wired data communication with a network or a peripheral connection port (e.g., universal serial bus port) that allows connection to an external peripheral. In some embodiments, the communication device 772 is a wireless communication device that allows data communication with a network access point or data communication with a local peripheral, such as a Bluetooth or 802.11 peripheral.

In some embodiments, identifying a functional component in a CAD model (such as described in relation to FIG. 6) is at least partially determined by a machine learning (ML) system. FIG. 8 is a schematic representation of an ML model that may be used with one or more embodiments of systems and methods described herein. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as a model, components, subcomponents, and properties or values thereof. For example, an instance may refer to any existing model of an adaptive peripheral. For example, an existing model of an adaptive peripheral may include designated functional components, and the ML model may learn the appearance, shape, or other properties or tags associated with the functional components.

In some embodiments, the machine learning system has a plurality of layers with an input layer 878 configured to receive at least one input training dataset 874 or input training instance 876 and an output layer 882, with a plurality of additional or hidden layers 880 therebetween.

In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes 884), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters 886, to the output layer.

In some embodiments, each of the nodes 884 has a linear function and an activation function. The linear function may attempt to optimize or approximate a solution with a line of best fit. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs (such as designated functional and/or fit components. In some embodiments, unsupervised learning can identify clusters of similar labels or characteristics for a variety of training instances and allow the machine learning system to extrapolate the designations of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset. In at least one embodiment, a system or method according to the present disclosure can improve performance, improve comfort, and/or reduce costs for users requiring adaptive peripherals.

### INDUSTRIAL APPLICABILITY

The present disclosure generally relates to systems and methods for manufacturing a peripheral for an electronic device. More particularly, systems and methods described herein allow for manufacturing of a customized adaptive peripheral for use with electronic devices.

In some embodiments, systems and methods according to the present disclosure allow a user to customize one or more parts of a peripheral prior to manufacturing, such that the manufactured part(s) meet the user's needs while remaining interoperable with other components of the peripheral. Systems and methods according to the present disclosure may reduce costs and manufacturing time while improving comfort and performance of the manufactured adaptive peripherals.

Depending on a user's physical abilities, an adaptive peripheral for the user may require customized dimensions, weight, resistance, shape, material, or color. Conventionally, a custom adaptive peripheral is commissioned and crafted by hand to the user's specifications. Newer manufacturing methods may use additive manufacturing or three-dimensional (3D) printing to rapidly produce a custom part to the user's specifications. However, modeling and designing the custom part for additive manufacturing conventionally requires computer assisted design (CAD) modeling software and experience using the CAD modeling software, which creates another barrier for users needing adaptive peripherals.

In some embodiments, a base model of a peripheral is obtained, and a user provides changes to the base model that can be applied to one or more components of the model to allow the alterations to accommodate the user's needs while the parts remain interoperable and compatible with one another to simplify manufacturing and assembly. For example, an existing CAD model may include a plurality of components to the CAD model that are independently editable. In some embodiments, a system or method according to the present disclosure identifies at least one component of the plurality of components as a fit component, which is editable to the user for customization purposes, and identify at least one component as a functional component, which is non-editable or locked to the user for customization purposes. In at least one example, the user has the option to alter or customize the CAD model through a webpage or web portal by changing properties and/or values of the fit components, while the properties and/or values of the functional components remain locked.

Peripheral controllers can meet the needs of a variety of individuals by allowing the functionality of a conventional controller to be divided or duplicated across the peripheral controllers through a controller hub. The controller hub has a plurality of ports therein to allow peripheral controllers to provide adaptive input mechanisms for users with limited or different mobility. For example, a user with limited mobility in her left hand may have a challenge providing directional inputs on the left thumbstick of a conventional game controller, such as a MICROSOFT XBOX CONTROLLER, an adaptive controller/peripheral can provide a secondary input to provide directional inputs via an adaptive controller/peripheral.

Adaptive peripherals may be connected to a hub with one or more inputs on the hub to provide additional or secondary inputs. In some embodiments, an adaptive peripheral is connected to a hub with one or more inputs to provide inputs independently of input mechanism on the hub. In some embodiments, a hub has a directional input device and a plurality of input buttons. The hub has a plurality of input ports into which a connector may be inserted to connect an adaptive peripheral device and through which the adaptive peripheral device may communicate with the hub and a game console or other computer connected to and in communication with the hub.

In some embodiments, a CAD model (e.g., JAVASCRIPT computer assisted design (JSCAD), .stl format, .stp format, or other open-source or propriety format) is of an adaptive peripheral that may connect to a hub (such as the hub described herein). The model includes and/or represents a plurality of components in the adaptive peripheral. In some embodiments, the plurality of components includes fit components and functional components. The functional components include any component or part of the model that includes a connection interface with another component or a mechanical or electrical interface to receive an input to the peripheral. In some embodiments, the fit components include any remaining portion of the CAD model that is not a functional component.

In some embodiments, the fit components include a housing, a stick, a button topper or other force input surface, a grip, a handle, a mouthpiece, or other portion of the model that corresponds to a contact surface or other surface of the peripheral that a user may touch during use. The fit components may be editable to alter one or more properties or values to improve the comfort or performance of the adaptive peripheral for the user. For example, increasing a height of the stick above the housing may increase the leverage a user applies to the stick for directional inputs, reducing fatigue and improving comfort. In another example, decreasing the height of the stick above the housing can reduce the travel distance of the stick relative to the housing (e.g., the stick moves less when pushed through a 45° range of motion), which may improve control for a user and improve comfort while providing directional inputs to the adaptive peripheral.

In some embodiments, the editable properties or values of the fit component of a model include any of length, width, height, thickness, perimeter shape (such as a plan-view or cross-sectional view shape), color, or material. In some embodiments, the material may be changed or selected based on one or more desired material properties, such as a coefficient of friction (such as for a grip), an elastic modulus (such as for a flexible fit component), or a vibration damping property. For example, a model may include a plurality of available materials and a user selection of a coefficient of friction may cause the material assigned to the fit component to change in the model to approximate or match the desired coefficient of friction. In another example, a model may include a plurality of available materials and a user selection of a compressibility of a grip (such as for an input mechanism that receives an input from a user compressing a stick in their grip) may cause the material assigned to the fit component to change in the model to approximate or match a desired elastic modulus. In other examples, a change to the wall thickness of the grip may allow the same material to exhibit the same compressibility.

The model may include a value or characteristic associated with each component of the model that designates the component as either a functional component or a fit component. For example, a model may include discrete components within the model that combine to form the complete model of the adaptive peripheral. In some embodiments, a model according to the present disclosure allows for subcomponents of a single component, where each subcomponent may be designated a fit component or a functional component.

In some embodiments, a model includes at least a component (e.g., a stick) that includes both fit components and functional components. In some embodiments, at least one fit component or functional component is subcomponent of another component. For example, in the illustrated embodiment, the stick includes a portion that includes a threaded interface that is a functional component, a second portion that includes a support and enclosure for a mechanical switch, where the support is also a functional component (along with the mechanical switch). The functional components have at least dimensions or other properties that become locked or non-editable in the model properties to ensure the functional components continue to be interoperable with other functional components of the model.

In some embodiments, the functional components include a mechanical switch, an optical switch, a magnetic switch, a pressure sensor, a potentiometer, a connection interface, or other components or subcomponents that measure inputs and/or connect a part of the peripheral to another part of the peripheral. For example, the threaded interface of the stick is designated as a functional component to ensure the complementary interface of the potentiometer will connect to the stick. In some embodiments, editable properties or values of the functional components include color or other properties that will not alter the function, size, or shape of the functional components.

As described above, a model may be or include an assembly that, in turn, includes a plurality of components that, in turn, include a plurality of subcomponents. The components and subcomponents may each be a fit component or a functional component. In some embodiments, a component includes integrally formed subcomponents. An embodiment of a stick may include a first subcomponent including the threaded interface (e.g., to screw onto a potentiometer) and a second subcomponent including a support for a mechanical switch (e.g., an input button). The stick may include a third subcomponent that includes a body that connects the first subcomponent to the second subcomponent.

In some embodiments, the stick is integrally formed from a single piece of material, and many conventional CAD models may consider the stick to have a single set of dimensions in the component properties. However, in some embodiments, the first subcomponent and second subcomponents are functional components, while the third subcomponent of the stick is a fit component.

When scaling a height of the stick indiscriminately, the aspect ratio of all portions of the stick may be foreshortened equally, producing a foreshortening of the first subcomponent and second subcomponent. For example, a pitch of the threaded interface changes, rendering the threaded interface of the first subcomponent incompatible with the threaded interface of the potentiometer for measuring a position of the stick. In another example, a depth of the support for the mechanical switch of the button is reduced, compromising the retention of the mechanical switch in the stick. To ensure the functional components of the stick component maintain interoperability, the third subcomponent including the body of the stick should be foreshortened.

In another example, the third subcomponent including the body is a fit component and allows the user to edit the dimensions of the third subcomponent. In some embodiments, the dimensions (and, optionally, other properties) of functional components (e.g., the first subcomponent and second subcomponent) remain fixed during the alteration of the height of the stick component. Therefore, the dimensions of the threaded interface and the support included in the first subcomponent and second subcomponent remain unchanged, and the threaded interface and the support maintain interoperability with other components of the assembly in the model.

In some embodiments, a method of manufacturing a custom peripheral for providing inputs to an electronic device includes, at a computing device, obtaining a model of a peripheral, where the model is an assembly containing a plurality of components. In some embodiments, at least one component of the model has a plurality of subcomponents. In some embodiments, obtaining the model includes receiving the model at a processor or system memory from a local hardware storage device. In some embodiments, obtaining the model includes receiving the model at a processor or system memory from a remote hardware storage device, such as from cloud storage or another server computer accessed via a network.

The method further includes identifying one or more fit components of the model. In some embodiments, identifying one or more fit components of the model includes reading at least one property of the components and/or subcomponents of the model. For example, some models obtained according to an embodiment of the method described herein may include a fit component property or tag in the properties of the CAD model.

In some embodiments, the method further includes identifying one or more functional components of the model. In some embodiments, identifying one or more functional components of the model includes reading at least one property of the components and/or subcomponents of the model. For example, some models obtained according to an embodiment of the method described herein may include a functional component property or tag in the properties of the CAD model.

The method further includes, in some embodiments, receiving at least one change to the model. In some embodiments, the change is received from a webpage or web portal that provides the change at least one property of the model. In some embodiments, the change is received at the computing device from a human interface device connected to the computing device. Based at least partially on the at least one change, the method further includes changing at least one property of a fit component of the one or more fit components without altering a functional component of the plurality of components. As described herein, the properties and/or values of the functional components may be locked from alteration to maintain interoperability of the functional components. The properties of the fit component(s) are editable to allow the user to customize a fit of the peripheral to the user's body for comfort and performance.

In some embodiments, the method includes providing at least an altered fit component to an additive manufacturing device. The additive manufacturing device may then print a physical part according to the properties and/or values of the altered fit component to produce part of the peripheral.

In some embodiments, the CAD model does not include properties and/or values to distinguish between fit components and functional components. In at least one embodiment, the CAD model is a unitary model that includes only one component.

A method of manufacturing an adaptive peripheral from a model lacking information about fit components and/or functional components includes, in some embodiments, obtaining a model of a peripheral at a computing device, but the model does not include properties and/or values to distinguish between fit components and functional components. The method then includes identifying the functional components and fit components to distinguish therebetween before alterations are made to a component or subcomponent of the model.

In some embodiments, the method includes identifying one or more functional components of the model. In some embodiments, identifying one or more functional components includes parsing a component name, title, properties, or values to identify a term associated with functional components, such as “switch”, “thread”, “button”, or “connector” that allows the computing device to identify a component as a functional component. In some embodiments, the computing device uses object recognition to identify functional components, such as identifying a helical structure as a threaded interface. The computing device may designate the identified component as a functional component and subsequently identify at least one remaining component of the model that is not a functional component of the one or more functional components of the model. The identified remaining component is then designated as a fit component.

In some embodiments, the method splits a unitary model (i.e., a model received without any components of the model) based at least partially on object recognition to identify functional components, such as identifying a helical structure as a threaded interface. The computing system may then designate a portion of the model adjacent to the functional component as part of the functional component to ensure that alterations to a remaining portion of the model do not compromise the interoperability of the identified functional component.

The method further includes receiving at least one change to the model and changing at least one property of the fit component without altering a functional component of the one or more functional components of the model before providing at least an altered fit component to an additive manufacturing device.

In some embodiments, a system for manufacturing an adaptive peripheral includes a computing device in data communication with an additive manufacturing device. In some embodiments, the computing device is further in data communication with a network through which the computing device may obtain models of peripherals. In some embodiments, the computing device is local to the additive manufacturing device. In some embodiments, the computing device is in data communication with the additive manufacturing device via the network.

The computing device includes a processor in data communication with a hardware storage device and in data communication with a communication device. In some embodiments, the hardware storage device is any non-transient computer readable medium that may store instructions thereon. The hardware storage device may be any type of solid-state memory; volatile memory, such as static random access memory (SRAM) or dynamic random access memory (DRAM); or non-volatile memory, such as read-only memory (ROM) including programmable ROM (PROM), erasable PROM (ERPOM) or EEPROM; magnetic storage media, such as magnetic tape; platen-based storage device, such as hard disk drives; optical media, such as compact discs (CD), digital video discs (DVD), Blu-ray Discs, or other optical media; removable media such as USB drives; non-removable media such as internal SATA or non-volatile memory express (NVMe) style NAND flash memory, or any other non-transient storage media. In some embodiments, the hardware storage device is local to and/or integrated with the computing device. The hardware storage device has instructions stored thereon that, when executed by the processor, cause the computing device to perform at least part of any of the methods described herein. In some embodiments, the computing device may communicate with the additive manufacturing device to perform at least a part of a method. For example, providing at least the altered fit component to the additive manufacturing device may cause the additive manufacturing device to change filaments for a printing of the part corresponding to the altered fit component.

In some embodiments, the communication device is a wired communication device, such as an ethernet network card that allows wired data communication with a network or a peripheral connection port (e.g., universal serial bus port) that allows connection to an external peripheral. In some embodiments, the communication device is a wireless communication device that allows data communication with a network access point or data communication with a local peripheral, such as a Bluetooth or 802.11 peripheral.

In some embodiments, identifying a functional component in a CAD model is at least partially determined by a machine learning (ML) system. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as a model, components, subcomponents, and properties or values thereof. For example, an instance may refer to any existing model of an adaptive peripheral. For example, an existing model of an adaptive peripheral may include designated functional components, and the ML model may learn the appearance, shape, or other properties or tags associated with the functional components.

In some embodiments, the machine learning system has a plurality of layers with an input layer configured to receive at least one input training dataset or input training instance and an output layer, with a plurality of additional or hidden layers therebetween.

In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters, to the output layer.

In some embodiments, each of the nodes has a linear function and an activation function. The linear function may attempt to optimize or approximate a solution with a line of best fit. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs (such as designated functional and/or fit components. In some embodiments, unsupervised learning can identify clusters of similar labels or characteristics for a variety of training instances and allow the machine learning system to extrapolate the designations of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset. In at least one embodiment, a system or method according to the present disclosure can improve performance, improve comfort, and/or reduce costs for users requiring adaptive peripherals.

The present disclosure relates to systems and methods for manufacturing a peripheral device according to at least the examples provided in the sections below:

[A1] In some embodiments, a method of manufacturing an electronic device peripheral includes obtaining a model of a peripheral, where the model has a plurality of components. The method further includes identifying one or more fit components of the model and identifying one or more functional components. The method includes receiving at least one change to the model and, based at least partially on the at least one change, changing at least one property of a fit component of the one or more fit components without altering a functional component of the plurality of components before providing at least an altered fit component to an additive manufacturing device.

[A2] In some embodiments, the at least one property of the first component of [A1] includes a dimension of the fit component.

[A3] In some embodiments, the at least one property of the first component of [A1] or [A2] includes a material property of the fit component.

[A4] In some embodiments, changing the material property of [A3] changes an elastic modulus property of the fit component.

[A5] In some embodiments, the at least one property of the first component of any of [A1] through [A4] includes a perimeter shape property of the fit component.

[A6] In some embodiments, the at least one property of the first component of any of [A1] through [A5] includes a mass property of the fit component.

[A7] In some embodiments, the one or more functional components of any of [A1] through [A6] includes one or more of a mechanical switch, a magnetic switch, a light switch, and a potentiometer.

[A8] In some embodiments, the method of any of [A1] through [A7] includes additively manufacturing a part of the peripheral corresponding to the altered fit component.

[A9] In some embodiments, providing at least an altered fit component of any of [A1] through [A8] includes sending the altered fit component via a network from a client device.

[A10] In some embodiments, the one or more functional components of any of [A1] through [A9] includes a connection interface.

[A11] In some embodiments, the change to the model of any of [A1] through [A10] includes a change to a dimension of the model.

[B1] In some embodiments, a method of manufacturing an electronic device peripheral includes obtaining a model of a peripheral, where the model having a plurality of components. The method further includes identifying one or more functional components of the model and identifying at least one remaining component of the model that is not a functional component of the one or more functional components of the model. The method includes designating one or more of the at least one remaining components of the model as a fit component. The method includes receiving at least one change to the model and, based at least partially on the at least one change, changing at least one property of a fit component of the one or more fit components without altering a functional component of the plurality of components before providing at least an altered fit component to an additive manufacturing device.

[B2] In some embodiments, model of [B1] is a unitary model when obtained.

[B3] In some embodiments, identifying one or more functional components of [B1] or [B2] includes inputting at least a portion of the model into a machine learning (ML) system.

[B4] In some embodiments, the ML system of [B3] identifies at least one connection interface.

[B5] In some embodiments, the peripheral of any of [B1] through [B4] is an adaptive electronic device peripheral.

[C1] In some embodiments, a system for manufacturing an electronic device adaptive peripheral includes an additive manufacturing device and a computing device in data communication with the additive manufacturing device. The computing device includes a processor, a communication device in data communication with the processor, and a hardware storage device in data communication with the processor. The hardware storage device has instructions stored thereon that, when executed by the processor, cause the computing device to obtain a model of a peripheral, where the model has a plurality of components. The instructions further cause the computing device to identify one or more fit components of the model and identify one or more functional components. The instructions further cause the computing device to receive at least one change to the model and, based at least partially on the at least one change, change at least one property of a fit component of the one or more fit components without altering a functional component of the plurality of components before sending a transmission to the additive manufacturing device to manufacture a part of the peripheral corresponding to an altered fit component.

[C2] In some embodiments, the at least one property of the fit component of [C1] includes a material property, and the transmission to the additive manufacturing device includes a request to change filament material.

[C3] In some embodiments, wherein the computing device of [C1] or [C2] is local to the additive manufacturing device.

[C4] In some embodiments, the transmission of any of [C1] through [C3] to the additive manufacturing device further causes the additive manufacturing device to manufacture a second part of the peripheral corresponding to a functional component.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of manufacturing an electronic device peripheral, the method comprising:
obtaining a model of a peripheral, the model having a plurality of components;
identifying one or more fit components of the model;
identifying one or more functional components;
receiving at least one change to the model;
based at least partially on the at least one change, changing at least one property of a fit component of the one or more fit components without altering a functional component of the plurality of components; and
providing at least an altered fit component to an additive manufacturing device.

2. The method of claim 1, wherein the at least one property of the fit component includes a dimension of the fit component.

3. The method of claim 1, wherein the at least one property of the fit component includes a material property of the fit component.

4. The method of claim 3, wherein changing the material property changes an elastic modulus property of the fit component.

5. The method of claim 1, wherein the at least one property of the fit component includes a perimeter shape property of the fit component.

6. The method of claim 1, wherein the at least one property of the fit component includes a mass property of the fit component.

7. The method of claim 1, wherein the one or more functional components includes one or more of a mechanical switch, a magnetic switch, a light switch, and a potentiometer.

8. The method of claim 1, further comprising additively manufacturing a part of the peripheral corresponding to the altered fit component.

9. The method of claim 1, wherein providing at least an altered fit component includes sending the altered fit component via a network from a client device.

10. The method of claim 1, wherein the one or more functional components includes a connection interface.

11. The method of claim 1, wherein the change to the model includes a change to a dimension of the model.

12. A method of manufacturing an electronic device peripheral, the method comprising:
obtaining a model of a peripheral;
identifying one or more functional components of the model;
identifying at least one remaining component of the model that is not a functional component of the one or more functional components of the model;
designating one or more of the at least one remaining component of the model as a fit component;
receiving at least one change to the model;
based at least partially on the at least one change, changing at least one property of the fit component without altering a functional component; and
providing at least an altered fit component to an additive manufacturing device.

13. The method of claim 12, wherein the model is a unitary model when obtained.

14. The method of claim 12, wherein identifying one or more functional components includes inputting at least a portion of the model into a machine learning (ML) system.

15. The method of claim 14, wherein the ML system identifies at least one connection interface.

16. The method of claim 12, wherein the peripheral is an adaptive electronic device peripheral.

17. A system for manufacturing an electronic device adaptive peripheral, the system comprising:
an additive manufacturing device;
a computing device in data communication with the additive manufacturing device, the computing device including:
a processor;
a communication device in data communication with the processor;
a hardware storage device in data communication with the processor, the hardware storage device having instructions stored thereon that, when executed by the processor, cause the computing device to:
obtain a model of a peripheral, the model having a plurality of components;
identify one or more fit components of the model;
identify one or more functional components;
receive at least one change to the model via a network;
based at least partially on the at least one change, change at least one property of a fit component of the one or more fit components without altering a functional component of the plurality of components; and
send a transmission to the additive manufacturing device to manufacture a part of the peripheral corresponding to an altered fit component.

18. The system of claim 17, wherein the at least one property of the fit component includes a material property, and the transmission to the additive manufacturing device includes a request to change filament material.

19. The system of claim 17, wherein the computing device is local to the additive manufacturing device.

20. The system of claim 17, wherein the transmission to the additive manufacturing device further causes the additive manufacturing device to manufacture a second part of the peripheral corresponding to a functional component.
